(19) United States
(12) Patent Application Publication
(10) Pub. No.: US 2026/0253905 A1
(43) Pub. Date: Aug. 27, 2026

(54) A SCALABLE FABRICATION OF DEEPLY RECHARGEABLE ZINC BATTERY ANODE MATERIALS

(71) Applicants: GEORGIA TECH RESEARCH CORPORATION, Atlanta, GA (US); GP TECHNOLOGY & INNOVATION LIMITED, Hong Kong (CN)

(72) Inventors: Wenwei Zheng, Hong Kong (CN); Nian Liu, Marietta, GA (US); Evan Wilson, Newberry, FL (US)

(21) Appl. No.: 19/163,064

(22) PCT Filed: Mar. 7, 2024
(86) PCT No.: PCT/US2024/018898

§ 371 Date: Sep. 8, 2025

Related U.S. Application Data
(60) Provisional application No. 63/489,044, filed on Mar. 8, 2023.

(51) Int. Cl. H01M 4/62; H01M 4/02; H01M 4/36; H01M 4/48; H01M 10/26

(52) U.S. Cl. CPC H01M 4/628; H01M 4/366; H01M 4/48; H01M 10/26; H01M 2004/027; H01M 2300/0014

(57) ABSTRACT

Disclosed is a method of forming a plurality of core/shell nanoparticles comprising spray coating a plurality of ZnO particles with a carbon precursor to form a plurality of clusters having a ZnO-based core and a carbon-containing shell.

### CROSS-REFERENCE TO RELATED APPLICATIONS

This application claims the priority benefit of U.S. Provisional Patent Application Ser. No. 63/489,044, filed Mar. 8, 2023, entitled “SCALABLE FABRICATION OF DEEPLY RECHARGEABLE ZINC BATTER ANODE MATERIALS,” which application is hereby incorporated by this reference in its entirety.

### TECHNICAL FIELD

This application generally relates to a scalable fabrication of deeply rechargeable zinc battery anode materials and using the same in electrochemical cells.

### BACKGROUND

With the rapid increase in portable electronics and the global push towards vehicle electrification and smart grids, there is an increasing demand for large-scale, sustainable, eco-friendly, safe electrochemical energy storage systems (such as batteries, for example) with high energy/power density.

However, research in rechargeable batteries is mainly concentrated on lithium-based batteries. However, these batteries currently require non-aqueous electrolytes that often are toxic and hard to dispose of, posing environmental risks.

Water-based electrolyte-based rechargeable batteries with safety, high power, and large capacity can represent a sustainable alternative to lithium batteries. Especially the aqueous electrolyte battery with zinc metal anode has broad application prospects due to its abundance, high stability, low cost, and non-toxic characteristics. However, this type of alkaline battery still has disadvantages due to the corrosivity of alkaline electrolytes, the formation of dendrites, and the like. In addition, the existing water-based zinc batteries still have a small volume and capacity. If the volume is increased, the electrode and the current collector area will be increased correspondingly, which will lead to a relatively uneven distribution of voltage and current through the battery that can lead to a local over-potential on the surface of the positive electrode and, as a result, zinc salt precipitation can occur. Also, the surface of the negative electrode generates a local overpotential, which further promotes dendrite growth, zinc salt precipitation, and a larger current areal density. It is also easier to produce more side reactions. Therefore, if a large-volume water-based zinc battery needs to be obtained, it is necessary to solve the problems of dendrites and channel blockage. Some previous attempts were made to improve the water-based zinc battery performance. However, there is still a need for improvements in battery technology and the methods of making the same.

In order to compete with all available energy-storage systems, particularly in grid-scale energy storage, rechargeable aqueous zinc battery systems need to be made with affordable raw materials and use scalable material processing techniques.

These needs and other needs are at least partially satisfied by the present disclosure.

### SUMMARY

The present disclosure is directed to a method of forming a plurality of core/shell nanoparticles comprising spray coating a plurality of ZnO particles with a carbon precursor to form a plurality of clusters having a ZnO-based core and a carbon-containing shell.

In further aspects, disclosed are methods where the plurality of clusters having a ZnO-based core and a carbon-based shell are heated to carbonize the carbon-containing shell to form a carbon-based ion-sieving shell. In such exemplary and unlimiting aspects, the carbon-based ion-sieving shell is microporous.

In still further aspects, also disclosed is an electrochemical cell comprising: an anode electrode comprising a plurality of any of the disclosed herein core/shell nanoparticles and an aqueous electrolyte. In still further aspects, the disclosed herein electrochemical cell further comprises a cathode material.

Also disclosed is a system comprising any of the electrochemical cells disclosed herein.

Also disclosed herein is an article comprising any of the disclosed herein electrochemical cells or systems.

Additional advantages will be set forth in part in the description that follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIG. 1 shows a schematic of the principles of ion-sieving nanoshells. [reproduced from Y. Wu et al., “Ion-Sieving Carbon Nanoshells for deeply Rechargeable Zn-Based Aqueous Batteries,” Advanced, Energy Materials., vol. 8, no. 36, 2018 and used without modification under Creative Commons Attribution-Non-Commercial 3.0 Unported License].

FIG. 2 shows a cross-sectional SEM image showing the passivation of the Zn metal foil anode after charge-discharge cycling. The anode was 25 μm in thickness and 1 cm in diameter. The thickness of the ZnO passivation layer is ~2 μm. [Reproduced from Y. Yan et al., “A Lasagna-Inspired Nanoscale ZnO Anode Design for High-Energy Rechargeable Aqueous Batteries,” ACS Applied Energy Materials, Vol. 1, no. 11, 2018. Reproduced under Creative Commons Attribution-Noncommercial 3.0 Unported License].

FIGS. 3A-3D show spray drying synthesis of carbon-coated ZnO using scalable processes and low-cost carbon precursors. FIG. 3A shows the used spray dryer; FIG. 3B shows a polyurethane precursor (on the left) and resol precursor (on the right); FIG. 3C shows alumina tube furnace boats with sprayed polyurethane-based polymer-coated zinc oxide; and FIG. 3D shows 50 grams, 140 ml of carbon-coated zinc oxide 15:30:1200.

FIGS. 4A-4C depict a protocol for anode loading, pouch cell preparation, and testing under realistic testing conditions (FIG. 4A); components for cell assembly: pouch, Ti wire current collectors, and commercial cathode (FIG. 4B); and eight batteries undergoing cycle testing on the Landt LANHE battery tester (FIG. 4C).

FIGS. 5A-5J show scanning Electron Microscopy images of Zno@C formulations with ZnO to PU ratio of 15:30 (FIGS. 5A-5B), 15:15 for (FIG. 5C), and 15:5 for (FIG. 5D). Transmission Electron Microscopy images of Zno@C formulations with increasing amounts of polyurethane with ZnO to PU ratios of 15:5 (FIG. 5E), 15:10 (FIG. 5F), 15:15 (FIG. 5G), and 15:20 (FIG. 5H). FIG. 5I shows X-ray Photoelectron Spectroscopy for ZnO@C 15:20:1200. FIG. 5J shows a zinc leaching test showing the concentration of zinc in solution after initial shake and settling.

FIGS. 6A-6K show mages of resol-derived (FIG. 6A) and polyurethane-derived (FIG. 6B) ZnO@C anodes submerged in DI water. Transmission Electron Microscopy images of the ZnO@C formulations at different project points, showing the observed inconsistencies in the process. FIG. 6C shows ZnO@C formulation 10:10:250 with a highly regular carbon shell thickness of ~5 nm. FIG. 6D shows ZnO@C formulation 5:20:250 with a fairly regular carbon shell thickness of ~5 nm. FIG. 6E shows ZnO@C formulation 15:15:1200 with highly irregular carbon shell thickness. Nitrogen Porosimetry Adsorption/Desorption isotherms and pore size distribution (calculated via DFT method) of polydopamine and solution chemistry-based ZnO@C and of polyurethane and spray drying-based ZnO@C 15:20:1200, along with Thermogravimetric Analysis (TGA) curves of the two materials' carbon precursors. FIG. 6F shows Polydopamine-based ZnO@C isotherm [reproduced from Y. Wu et al., “Ion-Sieving Carbon Nanoshells for deeply Rechargeable Zn-Based Aqueous Batteries,” Advanced, Energy Materials., vol. 8, no. 36, 2018]. FIG. 6G shows Polydopamine-based ZnO@C pore size distribution [reproduced from Id.]. FIG. 6H shows the TGA curve of polydopamine annealing in an inert atmosphere [reproduced from S. Xiong, Y. Wang, J. Yu, L. Chen, J. Zhu, and Z. Hu, “Polydopamine particles for next-generation multifunctional biocomposites,” Journal of Materials Chemistry A, vol. 2, no, 20, 2014]. FIG. 6I shows polyurethane-based, spray-dried Zno@C 15:20:1200 isotherm. FIG. 6J shows polyurethane-based, spray dried ZnO@C 15:20:1200 pore size distribution. FIG. 6K shows the TGA curve of polyurethane annealing in an inert atmosphere [reproduced from G. Trovati, E. A. Sanches, S. C. Neto, Y. P. Mascarenhas, and G. O. Chierice, “Characterization of polyurethane resins by FTIR, TGA, and XRD,” Journal of Applied Polymer Science, vol. 115, No. 1, 2010]. FIGS. 6F, 6G, 6H, and 6K are reproduced with slight modifications under Creative Commons Attribution-Noncommercial 3.0 Unported License.

FIG. 7 shows a full cell testing comparison of different ZnO@C anode materials in full Ni—Zn alkaline batteries.

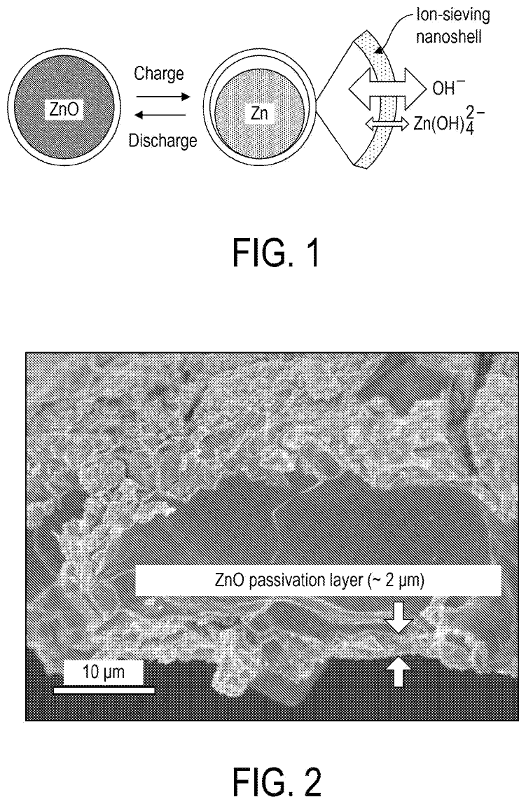

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a salt” includes two or more such elements, and a reference to “a battery” includes two or more such batteries and the like.

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Values can be expressed herein as an “average” value. “Average” generally refers to the statistical mean value.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range. It is further understood that if individual numbers within the range are disclosed, also disclosed are ranges formed by these individual numbers. For example, if the ranges, such as 1 to 3, from 1 to 4, from 1 to 5, from 2 to 4, from 2 to 6, from 3 to 6, etc., are disclosed as well as individual numbers within that range, for example, 1, 2, 2.7, 3, 4, 5, 5.3, 6 are disclosed, then additional subranges such as 1 to 2.7 or 2 to 5.3, and so on are also disclosed.

It is understood that the term “between,” when used in the context of ranges, includes the bordering values of the range. For example, a range described as being between 10 and 15 includes both 10 and 15 unless described otherwise.

In still further aspects, when the specific values are disclosed between two end values, it is understood that these end values can also be included. For example, if individual values of 1, 2, 3, 4, 5, 6, 7, etc. are disclosed, the ranges of 1 to 7, 1 to 6, 1 to 5, 1 to 4, 2 to 7, 3 to 7, and so on are also disclosed.

In still further aspects, when the range is given, and exemplary values are provided, it is understood that any ranges can be formed between any exemplary values within the broadest range.

References in the specification to a component described by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

As used herein, the term “composition” is intended to encompass a product comprising the specified ingredients in the specified amounts, as well as any product that results, directly or indirectly, from a combination of the specified ingredients in the specified amounts.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” “substantially identical reference article,” or “substantially identical reference electrochemical cell,” refers to a reference composition, article, or an electrochemical cell comprising substantially identical components and wherein an inventive component is substituted with a common in the art component.

The term “or combinations thereof” as used herein refers to all permutations and combinations of the listed items preceding the term. For example, “A, B, C, or combinations thereof” is intended to include at least one of A, B, C, AB, AC, BC, or ABC, and if the order is important in a particular context, also BA, CA, CB, CBA, BCA, ACB, BAC, or CAB. Continuing with this example, expressly included are combinations that contain repeats of one or more items or terms, such as BB, AAA, AB, BBC, AAABCCCC, CBBAAA, CABABB, and so forth. The skilled artisan will understand that, typically, there is no limit on the number of items or terms in any combination unless otherwise apparent from the context.

It is understood that the term “salt,” as used herein, refers to a chemical compound that can be formed from a reaction between an acid and a base. It is understood that the term “salt,” as used herein, encompasses both inorganic and organic salts capable of providing the desired properties to the composition. In still further aspects, a cation of the disclosed herein salts is a metal cation. It is also understood that all types of salts are disclosed. It is understood that both fully conjugated salts of strong bases and acids and weak bases and acids are also disclosed.

Spatially relative terms, such as “beneath,” “below,” “lower,” “above,” “upper,” “bottom,” “top,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

Electrochemical energy storage has been used since at least the turn of the 19th century when Alessandro Volta's “Volta pile” batteries enabled many new discoveries in chemistry and physics. Battery technology has progressed immensely since the first volta piles, and improvements in chemistry, packaging, and other factors have enabled energy density and power density of discharge to improve by orders of magnitude. Volta's original copper-silver cells could only discharge energy that had been stored in the anode during the smelting process of zinc, with the cathode reaction being the inefficient splitting of water to evolve hydrogen. Discharge for the Volta cell was irreversible. Modern battery research focuses exclusively on secondary batteries, which discharge reversibly and can be recharged from a circuit. Major events in the historical development of batteries are shown in Table 1. Battery electric vehicles are now poised to overthrow the internal combustion engine on their own merits of cost and performance. An even grander application of electrochemical energy storage technology may be on the near horizon: grid stabilization to enable the transition from fossil fuels to greater reliance on solar and wind.

TABLE 1
Major historical battery developments
from ref except where specified.

| Inventor | Year | Anode | Cathode | Advancement |
|---|---|---|---|---|
| Alessandro Volta | 1800 | Zn | Ag/H₂O | first battery |
| J. F. Daniell | 1836 | Zn | Cu | higher current and voltage |
| G. L. Leclanché | 1865 | Zn | MnO₂ | dry battery manufacturing |
| Gaston Planté | 1859 | Pb | PbO₂ | first rechargeable battery |
| W. Jungner | 1899 | Ni | Cd | more compact, more |
| | | | | robust |
| M. S. Whittingham et al. | 1976 [2] | Li/C | Li/alloy | more compact |

For much of the past 220 years, Zinc has been the anode material of choice for primary batteries due to its natural abundance and favorable properties. Zinc has a low negative standard reduction potential, which enables zinc anodes to pair with a variety of cathodes and has high energy density. A detriment that comes with zinc's electrode potential is that cell voltages of the most common electrode combinations fall outside of the stability window of water, and this has been a historical barrier to the broader adoption of Rechargeable Aqueous Zinc Batteries (RAZB). Other obstacles to the implementation of RAZBs include specific problems such as anode passivation and anode shape change and broader issues such as rate performance and cycling performance.

The battery market is currently growing rapidly, with the Lithium-Ion Batteries (LIB) market growing at a Compound Annual Growth Rate (CAGR) of 11% in dollar value. By storage capacity, the lithium battery market has grown at a CAGR of 24% between 1998 and 2016. This growth reflects the demand for energy storage for electronic devices and vehicles and is indicative of the rate of growth that may be seen in the near future demand for grid-scale energy storage capacity, for which LIB's energy density properties are unnecessary.

In the battery market, zinc batteries were first overthrown by Lead Acid Batteries (LAB) due to their rechargeability. Today, zinc batteries remain strongly represented in the primary (disposable, single-use) battery market, but LAB still dominates over the various RAZB chemistries in the much larger secondary battery market due to lead acid's similar low cost and high surge power density, which makes lead acid an appropriate system for gasoline automotive batteries. LIB, Nickel-Metal Hydride (NiMH), and other cell types have occupied battery niches that have emerged and for which RAZB chemistries are less suitable. The battery market in 2019 had a $120 Billion value and was 50% LAB, 46% LIB, and only 4% other. If cycle life can be improved, low-cost Nickel-zinc alkaline rechargeable batteries may displace NiMH for use in common consumer devices and perhaps also occupy the emerging niche of grid stabilization due to the natural abundance and low cost of Ni—Zn cell components.

Similarly, if cycle life is improved, Zinc-air batteries may occupy the emerging niche of electrified air travel due to the same cost advantages, high energy density, and other favorable performance metrics. In order to compete in these emerging applications, particularly in grid-scale energy storage, an RAZB system must be made with affordable raw materials and use scalable material processing techniques. Battery development must include testing conditions with real-world significance, meaning low-electrolyte and high areal capacity conditions must be used at least in some tests. Rate capability and cycle life in a full-cell configuration are the final variables that determine if battery technology has a promising future.

Rechargeable Nickel-Zinc alkaline batteries function by shuttling hydroxide ions between Nickel dihydroxide/Nickel oxyhydroxide cathode and zinc/zinc oxide anode. The preferred electrolyte is concentrated KOH in water.

The reactions occurring in Nickel-Zinc are as follows:

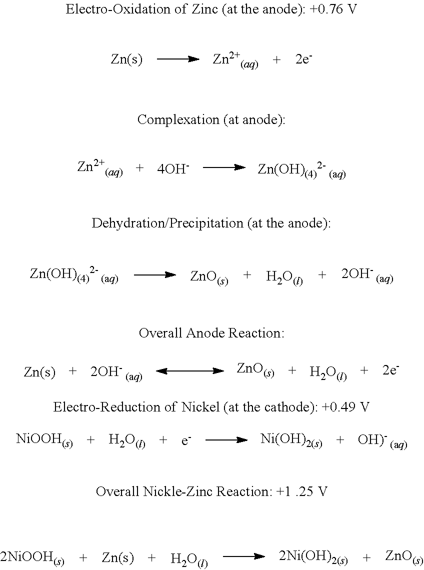

The primary challenges for the anode side of rechargeable nickel-zinc alkaline batteries have historically been dendrite growth, shape change, and passivation.

It is understood that a conventional RAZB uses an anode of pressed zinc metal powder, foil, or mesh, and therefore, a cycle life and energy density are limited by passivation, among other factors. Previously, it was found that the passivating ZnO layer on a zinc foil anode is approximately 2 μm thick and that attempted deep cycling to access the rest of the zinc metal underneath the 2 μm ZnO layer results in rapid capacity loss. Cross-section imaging of the foil and passivation layer measured previously is shown in FIG. 2. In order for areal discharge capacity not to be limited by passivation, the design of zinc anode morphology must be scaled to feature sizes on the same order of magnitude as the passivation layer.

In certain aspects, to improve zinc anode performance, zinc anode can be coated. In such aspects, the formed coating can have a microporous structure and can be permeable to ionic species of different sizes. For example, and without limitations, based on the ionic size of the hydroxide ion and zincate ion, the microporous coating can allow the anodic reaction to take place without hindering the hydroxide ion's diffusion to the anode surface while shape change driven by the solid-solute-solid reaction mechanism is mitigated.

This disclosure aims to develop a zinc anode material that can be easily commercialized and paired with an existing commercial cathode and aqueous electrolytes. The scalable methods of making such anode materials are disclosed herein.

Previously, the inventors have disclosed deeply rechargeable battery systems comprising core/shell nanoscale structures. These exemplary structures are disclosed in U.S. Patent Application No. 2022/0255068, the content of which is incorporated in its entirety by reference.

The current disclosure is directed to methods of producing various core/shell nanoparticles that can be utilized in recyclable aqueous zinc batteries. In certain aspects, disclosed herein is a method forming a plurality of core/shell nanoparticles. In such aspects, the methods comprise spray coating a plurality of ZnO particles with a carbon precursor to form a plurality of clusters having a ZnO-based core and a carbon-containing shell.

It is understood that spray coating can be accomplished by any known in the art methods. For example, and without limitations, the spray coating can be achieved by spray drying and/or spray pyrolysis. As one of the ordinary skills in the art would readily understand, the key difference between spray drying and spray pyrolysis is the temperatures involved. Spray drying achieves physical change (evaporation) and may also rapidly cure polymers due to the relatively high temperatures. Spray pyrolysis and flame spray pyrolysis are versatile techniques that use temperatures upwards of 1,000° C. to achieve major chemical changes in chemistry and morphology in a single step. The methods involve the formation of droplets. The droplets themselves can be generated by either pressure-driven, gas-assisted, ultrasonic-assisted, or gas-and-ultrasonic-assisted nozzles. Synthesized particles can then be recovered again by any method suitable for the desired purposes. For example, the particles can be recovered by filtration, electrostatic precipitation, and/or cyclone separation.

In still further aspects, the methods disclosed herein comprise a step of heating. In such exemplary and unlimiting aspects, the formed plurality of clusters having a ZnO-based core and a carbon-based shell are heated. It is understood that the heating step causes the carbon-containing shell to carbonize to form a carbon-based ion-sieving shell. In still further aspects, the shell is a conformal shell that substantially covers the core.

For example, and without limitation, in certain aspects, spray drying was used. In such exemplary and unlimiting aspects, a gas-assisted spray nozzle was utilized to form the clusters having the desired morphological change. The carbonization step then allows to achieve the desired chemical change. It is understood that different nozzles could also be used to arrive at the desired morphological change. In yet other aspects, instead of spray drying, one can utilize spray pyrolysis to arrive at the desirable results. In certain aspects, if spray pyrolysis is used, the spray solution comprises substantially fully soluble components. In such aspects, these components can then be used to achieve core-shell morphology. Yet in aspects where spray drying is used, the method comprises solid suspensions, where the solid becomes the core during spray drying.

In certain aspects, the methods disclosed herein use the carbon precursor that comprises an organic material. In still further aspects, the carbon precursor is an organic material. In still further aspects, the carbon precursor can comprise a polymeric material. In still further aspects, the carbon precursor is a polymeric resin.

In certain aspects, the carbon precursor used herein is a slurry. In such exemplary and unlimiting aspects, the slurry can comprise an organic material, water, and zinc oxide.

In still further aspects, the organic material can comprise phenolic resins. In yet other aspects, the organic material can comprise resol, resorcinol-formaldehyde, citric acid, sucrose, polyurethane, polyvinyl propylene (PVP), polyvinylalcohol (PVA), or any combination thereof.

In still further aspects, wherein a mass ratio of zinc oxide and the organic material is from about 3:1 to 1:2, including about 3:2 and about 1:1.

In still further aspects, the heating is at a temperature of about 500° C. to about 1,000° C., including exemplary values of about 550° C., about 600° C., about 650° C., about 700° C., about 750° C., about 800° C., about 850° C., about 900° C., and about 950° C. It is understood that the temperature can have any value between any two foregoing values. In yet further aspects, the temperature can fall within any range formed by any two foregoing values. For example, the temperature can be about 500° C. to about 900° C., or about 600° C. to about 1,000° C., about 700° C. to 1,000° C., about 800° C. to 1,000° C., or about 500° C. to about 800° C. and so on.

It is understood that the heating can be done in any suitable atmosphere. In certain aspects, the heating is in an inert atmosphere. It is understood that the inert atmosphere can comprise nitrogen, argon, helium, or any combination thereof.

In still further aspects, the plurality of clusters formed by the disclosed methods can have any shape suitable for the desired application. In certain aspects, the plurality of clusters having the ZnO-based core and the carbon-based ion-sieving shell have a substantially spherical shape. Yet, it is understood that the ZnO-based core can have an independent shape from the shape of the cluster. For example, in certain aspects, the ZnO-based core can have a substantially spherical shape. Yet, in other aspects, the ZnO-based core can have a rod-like shape or any other regular or irregular shape. It is understood that while disclosed herein are the plurality of core/shell nanoparticles comprising a plurality of ZnO particles as a core, the disclosed herein method can be used to form a core comprising Li, Na, Mg, Ca, Zn, Li₂O, Na₂O, MgO, CaO, ZnS, LizS, Na₂S, MgS, CaS, or any combination thereof as a core nanoparticles.

In still further aspects, the core can have any desirable size. In certain aspects, the core has a size of about 1 nm to about 10 μm, including exemplary values of about 2 nm, about 5 nm, about 10 nm, about 25 nm, about 50 nm, about 75 nm, about 100 nm, about 150 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 6 μm, about 7 μm, about 8 μm, and about 9 μm. In still further aspects, the core can have any value that falls between any two disclosed above values. In still further aspects, the core can have any range of values that is formed by any two disclosed above values. For example, the core size can be about 1 nm to about 500 μm, or about 1 nm to about 100 nm, or about 1 nm to about 2 μm, or about 100 nm to about 2 μm, or about 10 nm to about 10 μm, and so on. It is understood that if the core is substantially spherical, the values above are representative of an average diameter. If the core has a shape different from the substantially spherical shape, the disclosed above values represent an average value as it relates to the largest dimension of the core.

In yet still further aspects, the ZnO-based core comprises about 100 to about 10,000 ZnO nanoparticles, including exemplary values of about 150, about 200, about 300, about 400, about 500, about 600, about 700, about 800, about 900, about 1,000, about 2,000, about 3,000, about 4,000, about 5,000, about 6,000, about 7,000, about 7,000, and about 9,000 nanoparticles. It is understood that the ZnO-based core can comprise any number of nanoparticles that fall between any two of the foregoing values. In still further aspects, the ZnO-based core can have any range of nanoparticles that falls between any two of the foregoing values. For example, the ZnO-based core can comprise about 100 to about 9,500 nanoparticles, or about 100 to about 500 nanoparticles, or 100 to about 1,000 nanoparticles, or 1,000 to about 10,000 nanoparticles, or 100 to about 5,000 nanoparticles, or about 500 to about 10,000100 to about 9,500 nanoparticles, or about 2,000 to about 10,000 nanoparticles, or about 1,000 to about 5,500 nanoparticles, and so on.

In aspects disclosed herein, the carbon-based-ion sieving shell formed by the disclosed herein methods is microporous, having a pore size from about 0.01 nm to about 1 μm, including exemplary values of about 0.02 nm, about 0.03 nm, about 0.04 nm, about 0.05 nm, about 0.06 nm, about 0.07 nm, about 0.08 nm, about 0.09 nm, about 0.1 nm, about 0.5 nm, about 1 nm, about 2 nm, about 3 nm, about 4 nm, about 5 nm, about 6 nm, about 7 nm, about 8 nm, about 9 nm, about 10 nm, about 50 nm, about 100 nm, about 200 nm, about 300 nm, about 400 nm, about 500 nm, about 600 nm, about 700 nm, about 800 nm, and about 900 nm. In still further aspects, the pore size can have any value that falls between any two disclosed above values. In still further aspects, the pore size can have any range of value that is formed by any two disclosed above values. For example, the pore size can be about 0.01 nm to about 900 nm, or about 0.01 nm to about 500 nm, or about 0.01 nm to about 100 nm, or about 0.1 nm to about 100 nm, or about 0.1 nm to about 50 nm, or about 0.01 nm to about 50 nm, and so on.

In still further aspects, each cluster in the plurality of clusters can have a size from about 1 to about 20 μm, including exemplary values of about 2 μm, about 3 μm, about 4 μm, about 5 μm, about 6 μm, about 7 μm, about 8 μm, about 9 μm, about 10 μm, about 11 μm, about 12 μm, about 13 μm, about 14 μm, about 15 μm, about 16 μm, about 17 μm, about 18 μm, and about 19 μm. In still further aspects, cluster size can have any value that falls between any two disclosed above values. In still further aspects, the cluster size can have any range of values that is formed by any two disclosed above values. For example, the pore size can be about 1 μm to about 19 μm, or about 1 μm to about 15 μm, or about 1 μm to about 10 μm, or about 5 μm to about 15 μm, or about 10 μm to about 20 μm, and so on.

In still further aspects, wherein the carbon-based ion-sieving shell is permeable for OH⁻. In still further aspects, the carbon-based ion-sieving shell is impermeable for Zn⁺².

In still further aspects, the plurality of core/shell nanoparticles behave as an anode material.

Also disclosed herein are electrochemical cells comprising an anode electrode comprising a plurality of core/shell nanoparticles disclosed herein and an aqueous electrolyte.

In still further aspects, the electrolyte can comprise one or more zinc salts. In certain aspects, the one or more zinc salts comprise zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof. It is understood that the concentration of the one or more zinc salts can be in any desired range, for example, and without limitations, the concentration of the salt can be from about 0.1 M to about 3 M, including exemplary values of about 0.2 M, about 0.5 M, about 0.8 M, about 1 M, about 1.2 M, about 1.5 M, about 1.8 M, about 2 M, about 2.2M, about 2.5 M, and about 2.8 M. In still further aspects, the concentration of the salt can have any value that falls between any two disclosed above values. In still further aspects, the concentration of the salt can have any range of values that is formed by any two disclosed above values. For example, the concentration of the salt can be about 0.1 M to about 2.8 M, or about 0.5 M to about 2 M, or about 1 M to about 1.8, or about 0.5 M to about 1.5M, and so on.

In still further aspects, the aqueous electrolyte is an alkaline solution. In such exemplary and unlimiting aspects, a pH from is greater than about 7 to about 15, including exemplary values of about 7.5, about 8, about 8.5, about 9, about 9.5, about 10, about 10.5, about 11, about 11.5, about 12, about 12.5, about 13, about 13.5, about 14, and about 14.5. In still further aspects, the pH can have any value that falls between any two disclosed above values. In still further aspects, pH can have any range of values that is formed by any two disclosed above values. For example, the pH can be about 10 to about 14, or about 11 to about 14, or about 12 to about 14, or about 12 to about 14, or about 10 to about 15, or about 11 to about 15, or about 12 to about 15, or about 13 to about 15, and so on.

It is understood that in the event the core is different from ZnO, the electrolyte can be adjusted to contain a metal cation that would be suitable for the battery comprising an anode with a core different from ZnO.

In still further aspects, the electrochemical cells disclosed herein are batteries. In yet still further aspects, the electrochemical cell further comprises a cathode material. In such aspects, any cathodes suitable for the desired application can be utilized. In certain aspects, the cathode material comprises MnO₂ or any other manganese-based cathodes, VS₂, Fe₂O₂, V₂O₅, Prussian blue, vanadium-based cathodes, activated carbon, or Br₂.

In still further aspects where the electrochemical cell is a battery, it can comprise a separator. In such aspects, any known in the art suitable for the desired operation separator can be utilized. In certain aspects, the separator comprises ceramic or glass particles or fibers embedded in a polymeric matrix of textile fibers; cellulose-based film, polypropylene films, polypropylene/polyethylene films, fluorinated grafted polypropylene/polyethylene films, or a combination thereof.

In still further aspects, it is understood that the cells disclosed herein can have any desired size.

In still further aspects, the anode electrode of the disclosed herein electrochemical cell has a capacity from 1 mAh/cm² to 200 mAh/cm², including exemplary values of 5 mAh/cm², 10 mAh/cm², 20 mAh/cm², 30 mAh/cm², 40 mAh/cm², 50 mAh/cm², 60 mAh/cm², 70 mAh/cm², 80 mAh/cm², 90 mAh/cm², 100 mAh/cm², 110 mAh/cm², 120 mAh/cm², 130 mAh/cm², 140 mAh/cm², 150 mAh/cm², 160 mAh/cm², 170 mAh/cm², 180 mAh/cm², and 190 mAh/cm². In still further aspects, the capacity of the battery can have any value that falls between any two disclosed above values. In still further aspects, the capacity of the battery can have any range of values that is formed by any two disclosed above values. For example, the capacity of the battery can be about 1 mAh/cm² to about 190 mAh/cm², or about 1 mAh/cm² to about 150 mAh/cm², or about 10 mAh/cm² to about 180 mAh/cm², or about 1 mAh/cm² to about 100 mAh/cm², and so on.

In still further aspects, the battery exhibits a charge-discharge Coulombic efficiency of the cell greater than about 80% for at least about 50 cycles. In further aspects, the battery can exhibit a charge-discharge Coulombic efficiency of the cell from about 80% to about 100%, including exemplary values of about 85%, about 90%, about 95%, and about 99% for at least about 50 cycles. In still further aspects, the charge-discharge Coulombic efficiency can have any value that falls between any two disclosed above values. In still further aspects, the charge-discharge Coulombic efficiency can have any range of values that is formed by any two disclosed above values. For example, the charge-discharge Coulombic efficiency can be about 82% to about 100%, or about 85% to about 99%, or about 85% to about 95%, or about 99% to about 100%, and so on. In still further aspects, the battery exhibits a charge-discharge Coulombic efficiency of the cell greater than about 99% for at least about 50 cycles.

In still further aspects, the battery exhibits a charge-discharge Coulombic efficiency of the cell greater than about 80% for at least about 100 cycles, at least about 200 cycles, at least about 300 cycles, at least about 400 cycles, at least about 500 cycles, at least about 600 cycles, at least about 700 cycles, or at least about 1,000 cycles.

In still further aspects, the battery can exhibit a charge-discharge Coulombic efficiency of the cell from about 80% to about 100%, including exemplary values of about 85%, about 90%, about 95%, and about 99% for at least about 100 cycles, at least about 200 cycles, at least about 300 cycles, at least about 400 cycles, at least about 500 cycles, at least about 600 cycles, at least about 700 cycles, or at least about 1,000 cycles. In still further aspects, the battery can exhibit a charge-discharge Coulombic efficiency of the cell from about 80% to about 100%, about 85% to about 99.99%, about 99% to about 100% for at least about 100 cycles, at least about 200 cycles, at least about 300 cycles, at least about 400 cycles, at least about 500 cycles, at least about 600 cycles, at least about 700 cycles, or at least about 1,000 cycles.

In yet still further aspects, the battery exhibits a capacity retention of at least about 75%, at least about 80%, at least about 85%, at least about 90%, at least about 95%, or at least about 99%, over at least about 500 cycles.

In still further aspects, also disclosed is an electrochemical cell comprising: an anode electrode, wherein the anode electrode comprises a conductive host material and comprising an amount of at least one zinc-alloying metal; wherein the conductive host material is configured to accommodate zinc metal deposition during a plating cycle and wherein the deposited zinc metal is substantially free of dendrites; an aqueous electrolyte; and wherein the anode electrode exhibits at least about 50%, at least about 60%, at least about 70%, at least about 80%, at least about 90%, or about 100%, utilization and has a capacity from about 1 mAh/cm² to about 200 mAh/cm², including exemplary values of 5 mAh/cm², 10 mAh/cm², 20 mAh/cm², 30 mAh/cm², 40 mAh/cm², 50 mAh/cm², 60 mAh/cm², 70 mAh/cm², 80 mAh/cm², 90 mAh/cm², 100 mAh/cm², 110 mAh/cm², 120 mAh/cm², 130 mAh/cm², 140 mAh/cm², 150 mAh/cm², 160 mAh/cm², 170 mAh/cm², 180 mAh/cm², and 190 mAh/cm². The battery can show any of the disclosed above electrode utilization and has a capacity that can fall within any range formed by the two disclosed above values. In yet other aspects, the anode electrode exhibits about 100% utilization while demonstrating the disclosed above capacity.

In still further aspects, the anode formed by the disclosed herein methods have a depth of discharge (DOD) equal to or greater than about 50%, equal to greater than about 60%, equal to or greater than about 70%, equal to greater than about 80%, equal to or greater than about 90%, equal to greater than about 90%.

In certain aspects, disclosed herein are systems that can comprise two or more of the disclosed herein electrochemical cells. In certain aspects, the systems can comprise at least about 10, at least about 100, at least about 500, between about 10 and about 10,000, between about 100 and about 10,000, between about 1,000 and about 10,000, between about 10 and about 1000, between about 100 and about 1,000, or between about 500 and about 1,000 electrochemical cells of the present disclosure. Cells in such systems may be arranged in parallel or in series.

In still further aspects, disclosed herein are articles comprising any of the disclosed herein electrochemical cells or systems. In such aspects, the articles can comprise hand-held and/or wearable electronic devices, such as a phone, watch, or laptop computer; stationary electronic devices, such as a desktop or mainframe computer; an electric tool, such as a power drill; an electric or hybrid land, water, or air-based vehicles, such as a boat, submarine, bus, train, truck, car, motorcycle, moped, powered bicycle, airplane, drone, other flying vehicle, or toy versions thereof; for other toys. In still further aspects, the electrochemical cells disclosed herein can be used for energy storage, such as in storing electric power from wind, solar, wave, hydropower, or nuclear energy and/or in grid storage, or as a stationary power store for small-scale use, such as for a home, business, or hospital.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, the temperature in degrees C. or are at ambient temperature, and pressure is at or near atmospheric.

### Example 1

### Scalable Spray Synthesis

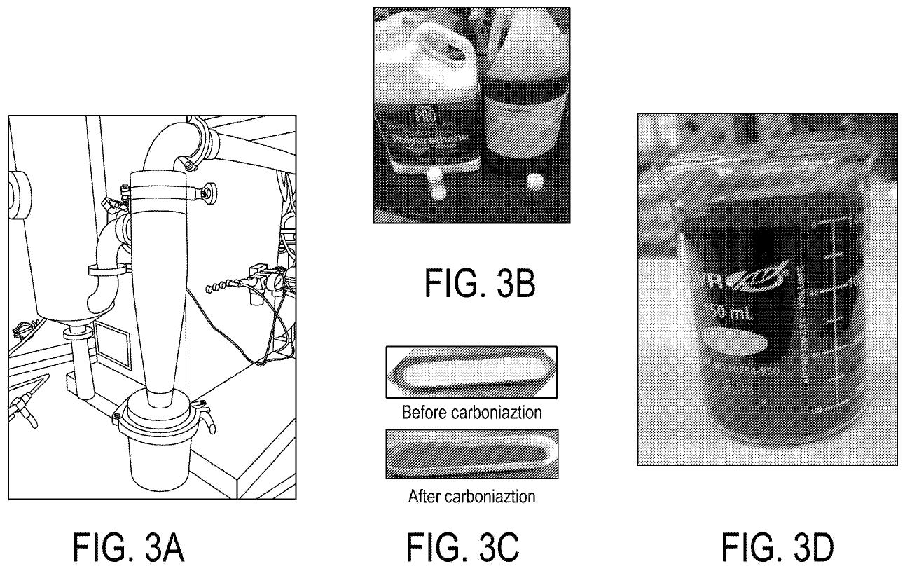

FIGS. 3A-3D demonstrate the equipment and conditions used to form the disclosed herein anode materials. In particular, it shows the carbon precursors used, the sprayed product before carbonizing/after carbonizing, and a large batch of 50 g of carbon-coated zinc anode material.

### Materials

ZnO (Sigma-Aldrich <5 μm), resol (Hexion Durite SC-1008), and water-based polyurethane (Parks Pro Finisher water-based polyurethane crystal-clear satin) were used to form the clusters of core/shell nanoparticles.

### Equipment

Spray drying of ZnO with polymer solution was conducted using a Shanghai Pilotech YC-500 Laboratory Spray Dryer. Carbonization was performed using a ThermoScientific Lindberg Blue M Mini-Mite Tube Furnace (1-inch).

### Methods

The Shanghai Pilotech YC-500 Laboratory Spray Dryer was configured and set up with a 1.5 mm spray nozzle, 2 bar gauge declogging pressure, pump set to 6 RPM (200 mL/h), 200° C. spray drying air inlet temperature, 80° C. spray drying air outlet temperature, air blower set to 30 Hz (2 m³/h). Hot air and declogging systems were allowed to come to a steady state before the spray solution feed started. The spray solution consisted of DI water, polymeric resin, and ZnO in an exemplary ratio of 15:30:1200 (mass ZnO:mass resin:mass DI water). All demonstrated masses are in grams. After spray drying all of the spray solution, polymer-coated ZnO (ZnO@PU) was collected from the spray dryer and carbonized. Carbonization was done in the 1-inch tube furnace in alumina boats under an inert gas (Argon) environment flowing at 2.5 L/min. Carbonization temperature was ramped up from room temperature to 600° C. in two hours, held at temperature for two hours, and then allowed to naturally cool under continuous Argon flow until around 100° C.

### Characterization

### Equipment

Transmission Electron Microscopy was conducted using the Hitachi HT-7700 TEM. Scanning Electron Microscopy was conducted using the Hitachi SU-8230 SEM. Thermal gravimetric analysis was conducted using TA Instruments Q500. Nitrogen porosimetry was conducted using the QUADRASORB evo surface area and porosity analyzer. Inductively Coupled Plasma spectroscopy was conducted by using the Perkin Elmer ICP-EOS model Optima 7300 DV. X-ray photoelectron Spectroscopy was conducted using the Thermo K-alpha XPS.

### Methods

### SEM

After focusing the microscope at 40,000× magnification and stigmatizing at 200,000× with a 6.5 mm working distance, individual particles were imaged at 10,000 × magnification, and the distribution of particle sizes was imaged at 1,000× magnification. Normal SEM imaging was done with the cold field emission gun set to 10 KV, and Energy Dispersive X-ray Spectroscopy (EDS) imaging was done with 15 kV.

### TEM

TEM mages of the carbon coating were taken at 100,000× magnification.

### Quick Carbon Test

To quickly measure the amount of carbon in ZnO@C samples, a silica boat, and a sample of known mass (about 200 mg) were heated in the tube furnace, increasing temperature to 12° C./min and held at 700° C. for one hour with an ambient air flowing into the tube furnace. The lost mass was assumed to be from carbon combustion.

### XPS

Full survey spectra were taken, and high-resolution scans were conducted for Zn 2p, O 1 s, C 1 s, and N 1 s peaks.

### Nitrogen Porosimetry

100 mg of the sample to be analyzed was weighed in an oven-dry glass bulb and dried overnight under vacuum down to 10 mTorr at 110° C., then backfilled with nitrogen. A Nitrogen adsorption/desorption isotherm was recorded on the QUADRASORB evo using default settings, and the pore size distribution was calculated using the built-in DFT method.

### Leaching Test

Powder amounts with weights normalized to 150 mg of ZnO were added to 5 g of 4M KOH. After 10 seconds of vigorous shaking by hand, the samples were allowed to rest for three minutes, and then 100 μL aliquots were taken from the surface of the samples. The shaking was repeated, and another aliquot was taken after an additional hour. No further shaking was done, and additional aliquots were taken at 24 hours, 7 days, and 15 days. Aliquots taken during testing were analyzed by Inductively Coupled Plasma Spectroscopy (ICP) to accurately determine dissolved ion concentrations, Zn in particular being of interest.

### Example 2

### Pouch Cell Testing Platform

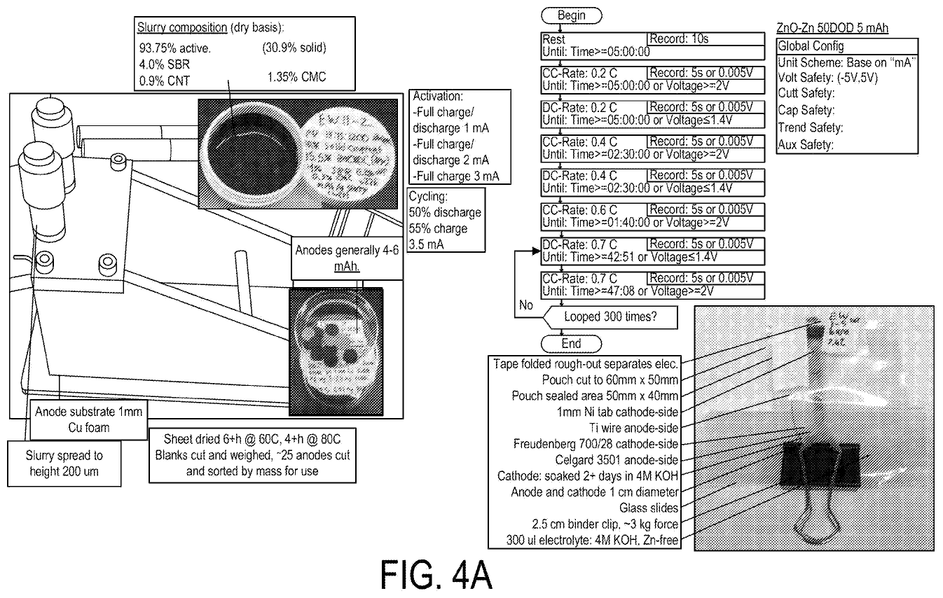

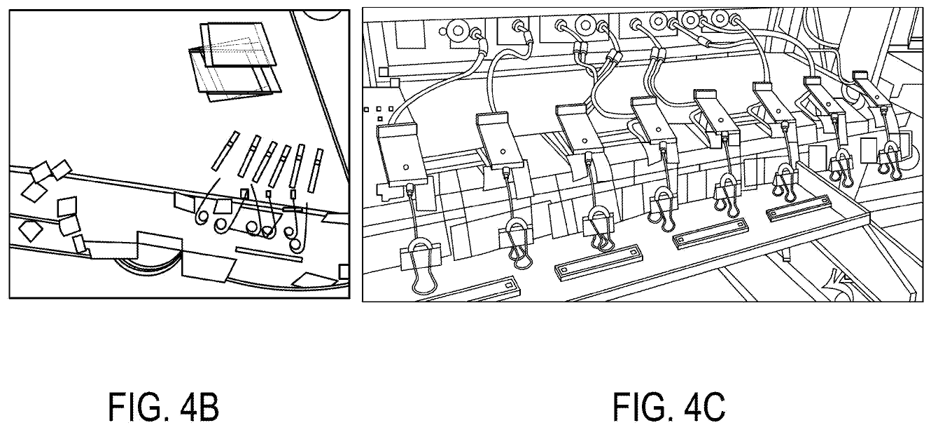

An overview of the pouch cell testing protocol for active materials is given in FIGS. 4A-4C.

### Materials

Freudenberg 700/28 hydrophilic fibrous separator, Celgard 3501 microporous polypropylene separator, PVDF (MTI PVDF binder), Styrene Butadiene Rubber (MTI SBR binder), Super P carbon black (MTI Corporation), water-based single-wall CNT suspension (Tuball Batt H2O 0.4% with CMC), Ti wire (Goodfellow 250 μm), Cu foam (1.5 mm Taobao), heat sealing polymer pouch (Kapal SealPAK 400), KOH (Sigma-Aldrich 99.99%).

### Equipment

Anode slurries were mixed using a Thinky Corporation AR-100 non-vacuum conditioning mixer. Batteries were cycled using a Landt CT3002AU 8-channel battery tester (Wuhan LANHE Electronics Corporation) with a 10-mA maximum current.

### Methods

The protocol developed over the course of testing. The essential steps of the testing protocol are shown in FIGS. 4A-4C. Two different combinations of binder/electron conductors were used in slurries for anode preparation before battery testing. The first choice of materials and proportions are based on a dry basis of 80% active material, 10% Super P carbon black, and 10% PVDF. Due to the proportion of active material being only 80% in the first slurry formulation, a change was made to conform more closely to industry standards. The later slurry formulation consisted of 0.9% Single, 1.35% Carboxymethylcellulose (CMC), and 4% Styrene-Butadiene Rubber (SBR). SWCNT/active material proportions and attempted structure were based on results from S. H. Park et al., “High areal capacity battery electrodes enabled by segregated nanotube networks,” Nature Energy, vol. 4, no. 7, 2019.

Slurry components (active material, binder, electron conductor, and water) were mixed in the Thinky conditioning mixer for 5-10 minutes to ensure good mixing at the micron scale. The anode slurry was applied to 1 mm Cu foam via a doctor blade set to 200 μm height and dried in a vacuum oven for four hours at 80° C. Batteries were assembled in pouch cell configuration with an anode side Ti wire current collector, 1 cm diameter anode disks punched from dried anode sheets, a dendrite-blocking microporous separator on the anode side, hydrophilic fibrous separator on the cathode side, pre-soaked commercial NiOOH cathode, and cathode side Ni tab current collector. 300 μl 4M KOH was used for simple electrolyte and flooded cell (as opposed to even leaner electrolyte), the air was pushed out by hand, and the pouch cell was sealed with a heat sealer. Glass slides were pressed on either side with a binder clip applying approximately 3 kg force and even pressure over the electrodes.

Cell activation and cycling protocols never arrived at a sure set of operating conditions, as it was unclear what conditions were optimal for the ZnO@C material, and the goal of the cycling protocol development was to isolate the performance of ZnO@C so that changes in performance caused by changes in formulation could be reliably measured. What might be called the typical cell cycle testing protocol included an activation step of full charge and discharge in increasing current density followed by cycling with 55% charge and 50% discharge. As assembled, both anode and cathode materials are initially in their discharged state, so the activation starts with a charge. Eight pouch cells being cycled on the LAND LANHE battery tester can be seen in FIG. 4C.

### Characterization

During this project, spray syntheses with all soluble components were attempted first, but this approach is likely more suitable for spray pyrolysis and was unsuccessful at forming core-shell morphology particles with spray drying and carbonization steps. Soluble zinc precursors of zinc nitrate and zinc acetate were attempted with the carbon precursor of PVP. The morphology of these products was globes of carbon, and ZnO stuck together rather than zinc oxide with a carbon coating. Rather than completely soluble components, solid ZnO nanoparticles with polymer coating were set as the new target. Resol was selected to be the carbon precursor since it had been used before for core-shell carbon coatings [16]. Polyurethane resin was used as an early polymer coating for solid ZnO to establish if this approach yielded the correct morphology and to have a material to begin work on the full-cell testing platform.

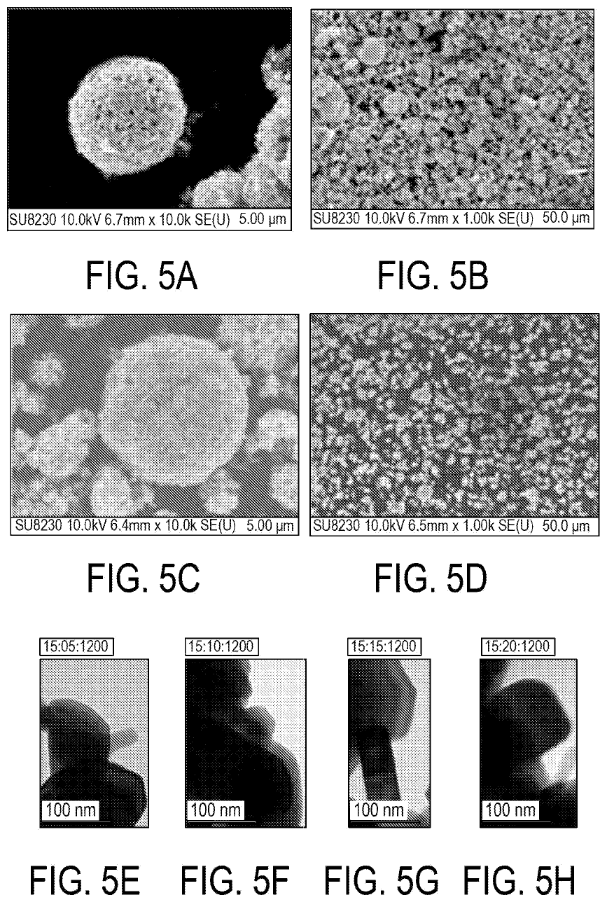

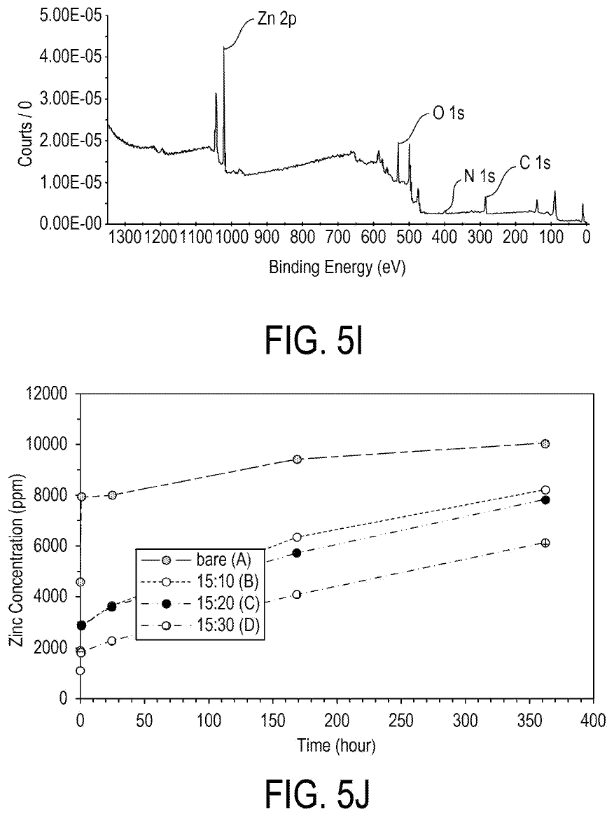

FIG. 5A shows a single ZnO@C microcomposite particle. The general morphology of microcomposite particles produced by spray drying and carbonization is the same for all formulations used in this work: roughly spherical clusters composed of between 1,000 and 10,000 ZnO nanoparticles inside a carbon coating. The other panels display a trend of average particle size generally decreasing as the amount of polyurethane in the spray solution formulation decreases. Particle size distributions appear to be quite broad, which can be attributed to the non-uniform drop size inherent in the spray drying process. FIGS. 5E-5H display TEM images of ZnO@C formulations with increasing amounts of polymeric carbon precursor relative to ZnO to be coated. Counterintuitively, there does not appear to be any trend in carbon shell thickness with increasing amounts of carbon precursor. This interesting result was also observed in a series of 15:10, 15:20, and 15:30 ZnO to polyurethane ratios, as well as with comparisons done with resol instead of polyurethane as the carbon precursor.

FIG. 5I shows a representative result for X-ray Photoelectron Spectroscopy of these materials, specifically for ZnO@C 15:20:1200. Peaks are identified only for Zn, O, N, and C. The atom percentages calculated from peak areas are shown in Table 2, with results from bare ZnO and three different formulations of polyurethane-derived ZnO@C, along with a literature result for another ZnO@C material derived from polydopamine as the carbon precursor [8]. The XPS results compared with the literature results indicate that contamination of the carbon precursor can be ruled out as a source of poor performance since the XPS data is almost identical to the literature result, which had a good performance. FIG. 5J shows the results of a test designed to show the efficacy of the carbon shell at limiting zinc migration. These tests were done using polyurethane-derived ZnO@C. A thicker carbon shell corresponded to less zinc dissolving into the aqueous 4M KOH electrolyte. The carbon shell is shown to slow the dissolution of zinc, but no ZnO@C formulation completely retains Zinc.

TABLE 2
XPS peak atomic percentages for different ZnO@C
formulations.

| | | | | | Poly- |
|---|---|---|---|---|---|
| | Bare | | | | dopamine- |
| Element | ZnO | 15:10:1200 | 15:20:1200 | 15:30:1200 | based |
| Zn | 40.66 | 15.97 | 17.51 | 17.29 | ~0 |
| O | 43.18 | 25.90 | 27.32 | 25.47 | ~0 |
| C | 16.16 | 53.52 | 50.94 | 51.70 | ~100 |
| N | 0 | 4.61 | 4.23 | 5.53 | ~0 |

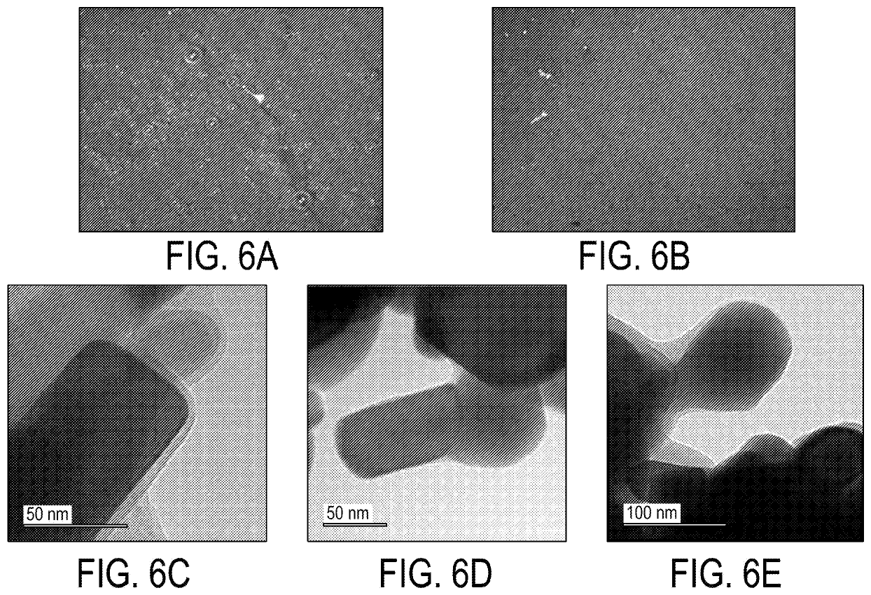

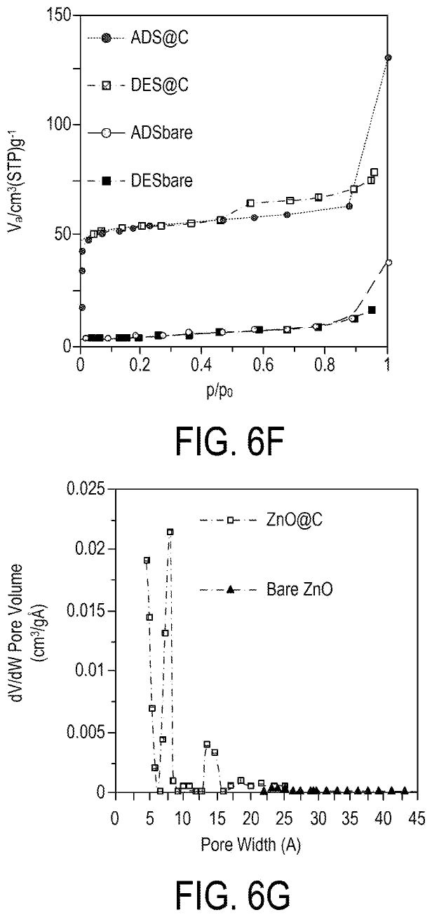

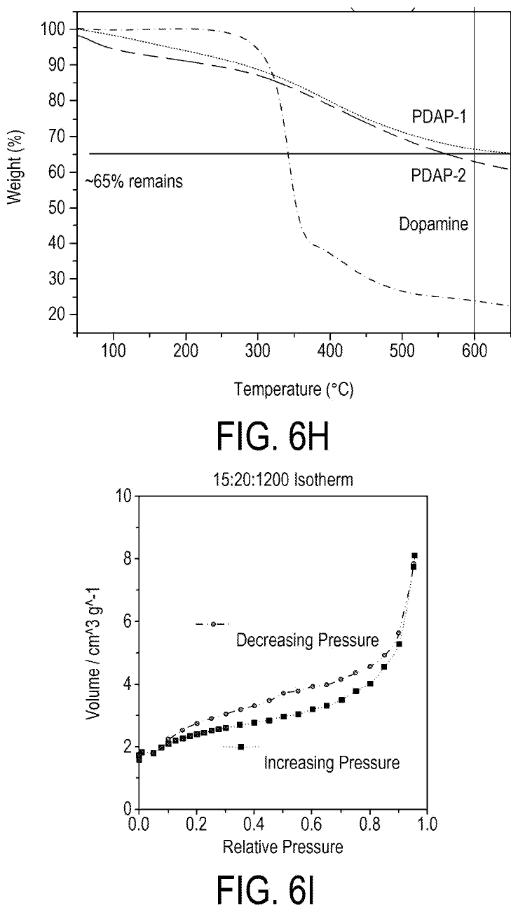

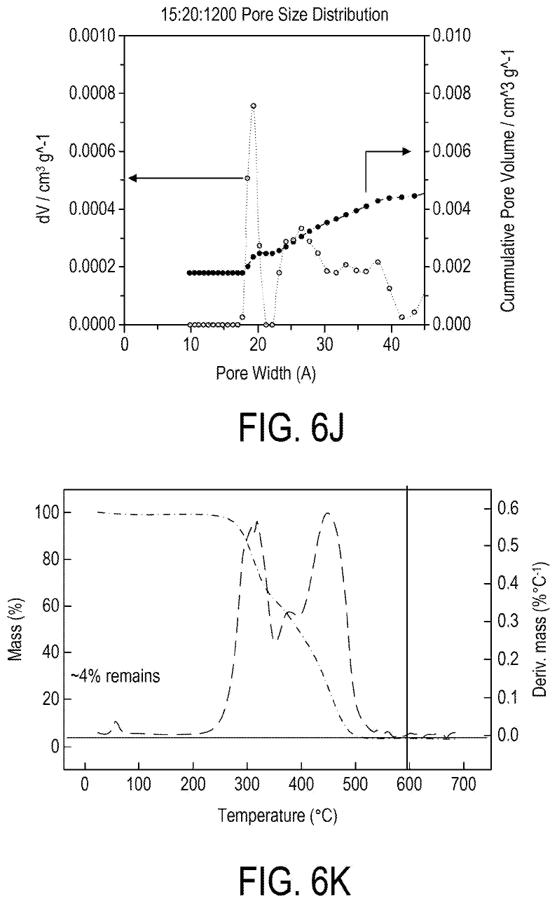

FIGS. 6A-6B show results for a test of spontaneous hydrogen evolution when submerged in DI water. Resol-derived carbon coatings appeared to catalyze hydrogen evolution in a localized electrochemical cell with zinc corrosion. This occurrence could potentially be addressed with hydrogen evolution suppressants, but due to the implications for cost, self-discharge, and coulombic efficiency, this property of the resol-derived coating resulted in a pivot back to polyurethane after testing had briefly transitioned to resol-derived carbon coatings, which had precedence in the literature whereas polyurethane-derived carbon coatings for battery materials do not appear to have any precedence in the literature.

FIGS. 6C-6E show the TEM images of carbon shells from two Zno@C formulations, which are shown along with a TEM image of a Zno@C formulation. This figure highlights the difficulties encountered with defining the processing-structure-property relationship.

FIGS. 6F-6K show results for Nitrogen Porosimetry and literature TGA curves compared polydopamine-derived carbon-coated ZnO from the literature and polyurethane-derived carbon coated ZnO from this work. The larger diameter pores in the polyurethane-derived carbon coating are the reason that FIG. 5J shows that zinc leaching is only slightly retarded. The pore size distribution is fundamental to the mechanism by which carbon coated ZnO materials are meant to improve RAZB performance. Without wishing to be bound by any theory, it is understood that a microporous structure of the shell allows to retain zincate and solves the problem of zinc migration and anode shape change.

### Pouch Cell Testing

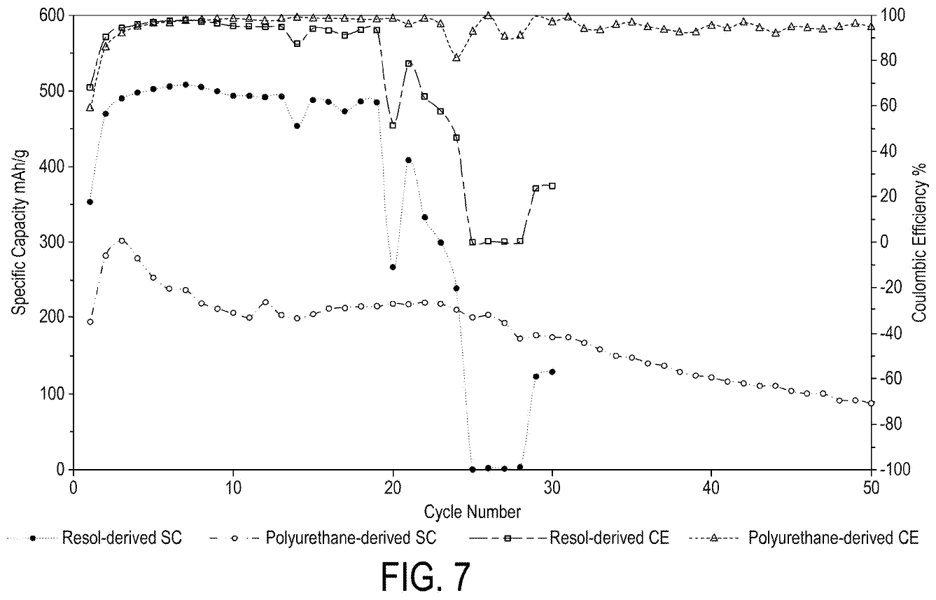

FIG. 7 shows the results of two early tests with resol-derived carbon coating and polyurethane-derived carbon coating. Both cells used an aqueous electrolyte of 4M KOH saturated with ZnO. Additional testing conditions are given in Table 3.

The resol-derived ZnO@C cells displayed high zinc utilization in early cycles with early cycle coulombic efficiency of around 90. It was found that the mechanical failure of the anode can affect the cell performance. The polyurethane-derived ZnO@C cells, while showing lower initial zinc utilization, demonstrated higher coulombic efficiency and slower capacity fade, which can be attributed to the lesser hydrogen evolution problem in polyurethane-derived carbon coatings compared to resol-derived carbon coatings. As the polyurethane precursor aged, the maximum zinc utilization decreased, and the long-term cycling capacity diminished. The same is true for the resol precursor, but not as pronounced.

TABLE 3
Testing Differences, for example,
ZnO@C Full-cell Testing

| | Resol- | Polyurethane- |
|---|---|---|
| | derived | derived |
| Property | ZnO@C | ZnO@C |
| Target Zinc Utilization | 100% | 100% |
| Upper Cutoff Voltage | 2.0 V | 2.0 V |
| Lower Cutoff Voltage | 1.4 V | 1.4 V |
| Anode Capacity/mAh | 6.1 | 7.2 |
| Electrolyte volume/ml | 0.3 | 0.2 |
| Slurry | 1.5% swcnt | 4% SBR, 0.2% swcnt |
| Capacity Cycling Rate | 0.2 | 0.5 |

### Morphology

The experimental results have shown that it is likely that some degradation of the polyurethane carbon precursor occurred after breaking the product seal, either due to oxidation by ambient air or by some other aging mechanism. Non-homogeneities in the polyurethane resin could be observed qualitatively when stirring before making the spray solution, and it appears likely that the level of stirring applied needs to be controlled to completely homogenize the polyurethane resin.

Without wishing to be bound by any theory, it was hypothesized that the aging of the polyurethane resin is possibly associated with the thermosetting properties of the cured polyurethane. It was hypothesized that during aging, a change occurs within the polyurethane which causes the polymer coating on ZnO to melt during the annealing/carbonization process, which would explain the accumulation in concave regions and depletion in convex regions observed in FIG. 5E. The accumulation/depletion observed in concave/convex regions could alternatively have its origin during the spray drying step. It is possible that fresh polyurethane resin either is more viscous or cures more rapidly and that aged resin cures slower or is less viscous and after the water has evaporated and the spray droplet has turned into a cluster of polyurethane-coated ZnO particles, surface tension acts to pull not-yet-cured resin into the concave regions of the cluster.

### Carbon Shell Quality

Without wishing to be bound by any theory, it was hypothesized that the carbon coating with resol may have a better performance than the carbon coating with polyurethane despite the hydrogen evolution issues. The higher percentage of carbon left behind on resol TGA curves indicates that resol formed a superior coating compared to polyurethane, likely with a pore structure that performs the ion-sieving function better than the PU-derived coating did, though this is uncertain since the pore size distribution and leaching rate were not measured for ZnO@C with resol-derived coating. An additional facet of the coating to consider is the electrical connection between the circuit and the zinc material within the carbon shell. A less dense carbon shell can be assumed to have more breaks in electrical connections, and so more patches of initial” dead zinc” and greater internal resistance during operation.

### Electrolyte and Testing Platform

It is understood that achieving a good electrical connection between various portions of the battery and the batteries' mechanical integrity are essential to obtaining superior results. Early testing used slurries of 10% Super P Carbon black and 10% PVDF. When initially switching to a water-based slurry system with SWCNT, 1.44% SWCNT and no binder were used initially. For this platform, no activation step was used, and the batteries were cycled to 100% specific capacity or to 2.0V full-cell cutoff with an anode-defined C-rate of 0.2 C. In this SWCNT-only platform, ZnO@C lasted only 4 cycles before capacity fell below 80% of the maximum capacity, after which capacity dropped off rapidly, whereas bare ZnO lasted 8 cycles before coulombic efficiency dropped and capacity fell below 80% of the maximum capacity.

### EXEMPLARY ASPECTS

Exemplary Aspect 1. A method of forming a plurality of core/shell nanoparticles comprising: spray coating a plurality of ZnO particles with a carbon precursor to form a plurality of clusters having a ZnO-based core and a carbon-containing shell.
Exemplary Aspect 2. The method of any one of exemplary aspects disclosed herein, particularly Exemplary Aspect 1, wherein the carbon precursor is an organic material.
Exemplary Aspect 3. The method of any one of exemplary aspects disclosed herein, particularly Exemplary Aspect 1 or 2, wherein the carbon precursor is a polymeric resin.
Exemplary Aspect 4. The method of any one of exemplary aspects disclosed herein, particularly Exemplary Aspects 1-3, wherein the plurality of clusters having a ZnO-based core and a carbon-based shell are heated to carbonize the carbon-containing shell to form a carbon-based ion-sieving shell.
Exemplary Aspect 5. The method of any one of exemplary aspects disclosed herein, particularly Exemplary Aspect 4, wherein the carbon-based ion-sieving shell is microporous.
Exemplary Aspect 6. The method of any one of exemplary aspects disclosed herein, particularly Exemplary Aspects 1-5, wherein the carbon precursor is a slurry comprising an organic material, water, and zinc oxide.
Exemplary Aspect 7. The method of any one of exemplary aspects disclosed herein, particularly Exemplary Aspects 2-6, wherein the organic material comprises resol, resorcinol-formaldehyde, citric acid, polyurethane, sucrose, polyvinyl propylene, polyvinylalcohol, or any combination thereof.
Exemplary Aspect 8. The method of any one of exemplary aspects disclosed herein, particularly Exemplary Aspects 6-7, wherein a mass ratio of zinc oxide and the organic material is from about 3:1 to 1:2.
Exemplary Aspect 9. The method of any one of exemplary aspects disclosed herein, particularly Exemplary Aspects 4-8, wherein the heating is at a temperature of about 500° C. to about 1,000° C.
Exemplary Aspect 10. The method of any one of exemplary aspects disclosed herein, particularly Exemplary Aspects 4-9, wherein the heating is an inert atmosphere.
Exemplary Aspect 11. The method of any one of exemplary aspects disclosed herein, particularly Exemplary Aspects 4-10, wherein the plurality of clusters having the ZnO-based core and the carbon-based ion-sieving shell have a substantially spherical shape.
Exemplary Aspect 12. The method of any one of exemplary aspects disclosed herein, particularly Exemplary Aspects 1-11, wherein ZnO-based core comprises from about 1,000 to about 10,000 ZnO nanoparticles.
Exemplary Aspect 13. The method of any one of exemplary aspects disclosed herein, particularly Exemplary Aspects 4-12, wherein the carbon-based ion-sieving shell is permeable for OH⁻.
Exemplary Aspect 14. The method of any one of exemplary aspects disclosed herein, particularly Exemplary Aspects 4-13, wherein the carbon-based ion-sieving shell is impermeable for Zn⁺².
Exemplary Aspect 15. The method of any one of exemplary aspects disclosed herein, particularly Exemplary Aspects 4-14, wherein the plurality of core/shell nanoparticles behave as an anode material.
Exemplary Aspect 16. An electrochemical cell comprising: an anode electrode comprising a plurality of core/shell nanoparticles of any one of exemplary aspects disclosed herein, particularly Exemplary Aspects 4-15 and an aqueous electrolyte.
Exemplary Aspect 17. The electrochemical cell of any one of exemplary aspects disclosed herein, particularly Exemplary Aspect 16, wherein the aqueous electrolyte comprises one or more zinc salts.
Exemplary Aspect 18. The electrochemical cell of any one of exemplary aspects disclosed herein, particularly Exemplary Aspect 17, wherein the one or more zinc salts comprises zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof.
Exemplary Aspect 19. The electrochemical cell of any one of exemplary aspects disclosed herein, particularly Exemplary Aspects 16-18, wherein the aqueous electrolyte has a pH from greater than 7 to about 15.
Exemplary Aspect 20. The electrochemical cell of any one of exemplary aspects disclosed herein, particularly Exemplary Aspects 16-19, wherein the electrochemical cell is a rechargeable battery.
Exemplary Aspect 21. The electrochemical cell of any one of exemplary aspects disclosed herein, particularly Exemplary Aspect 20, further comprising a cathode material.
Exemplary Aspect 22. The electrochemical cell of any one of exemplary aspects disclosed herein, particularly Exemplary Aspect 21, wherein the cathode material comprises MnO₂, manganese-based cathodes, VS₂, Fe₂O₂, V₂O₅, Prussian blue, vanadium-based cathodes, activated carbon, or Br₂.
Exemplary Aspect 23. The electrochemical cell of any one of exemplary aspects disclosed herein, particularly Exemplary Aspect 21 or 22, further comprising a separator.
Exemplary Aspect 24. The electrochemical cell of any one of exemplary aspects disclosed herein, particularly Exemplary Aspect 23, wherein the separator comprises ceramic or glass particles or fibers embedded in a polymeric matrix of textile fibers; cellulose-based film, polypropylene films, polypropylene/polyethylene films, fluorinated grafted polypropylene/polyethylene films, or a combination thereof.
Exemplary Aspect 25. The electrochemical cell of any one of exemplary aspects disclosed herein, particularly Exemplary Aspects 16-24, wherein the anode electrode has a capacity from about 1 mAh/cm² to about 200 mAh/cm².
Exemplary Aspect 26. The electrochemical cell of any one of exemplary aspects disclosed herein, particularly Exemplary Aspects 16-25, wherein the anode electrode exhibits about 100% utilization.
Exemplary Aspect 27. The electrochemical cell of any one of exemplary aspects disclosed herein, particularly Exemplary Aspects 16-26, wherein the electrochemical cell exhibits a charge-discharge Coulombic efficiency of the cell greater than about 90% for at least about 50 cycles.
Exemplary Aspect 28. The electrochemical cell of any one of exemplary aspects disclosed herein, particularly Exemplary Aspects 16-27, wherein the anode has a depth of discharge (DOD) equal to or greater than about 50%.
Exemplary Aspect 29. A system comprising one or more of the electrochemical cells of any one of exemplary aspects disclosed herein, particularly Exemplary Aspects 16-28.
Exemplary Aspect 30. An article comprising the electrochemical cell of any one of exemplary aspects disclosed herein, particularly Exemplary Aspects 16-28, or the system of any one of exemplary aspects disclosed herein, particularly Exemplary Aspect 29.

### REFERENCES

[1] V. S. Bagotsky, A. M. Skundin, and Y. M. Koltkovich, Electrochemical Power Sources. 2015.
[2] O. Ramstrom, “Scientific Background on the Nobel Prize in Chemistry 2019-Lithium Ion Batteries,” The Royal Swedish Academy of Sciences, vol. 50005, 2019.
[3] P. Bonnick and J. R. Dahn, “A Simple Coin Cell Design for Testing Rechargeable Zinc-Air or Alkaline Battery Systems,” Journal of The Electrochemical Society, vol. 159, no. 7, 2012.
[4] Y. Zhao et al., “A Review on Battery Market Trends, Second-Life Reuse, and Recycling,” Sustainable Chemistry, vol. 2, no. 1, 2021.
[5] M. S. Ziegler and J. E. Trancik, “Re-examining rates of lithium-ion battery Technology improvement and cost decline,” Energy and Environmental Science, vol. 14, no. 4, 2021.
[6] S. Chu, Y. Cui, and N. Liu, The path towards sustainable energy, 2016.
[7] J. Hao, X. Li, X. Zeng, D. Li, J. Mao, and Z. Guo, Deeply understanding the Zn anode behavior and corresponding improvement strategies in different aqueous Znbased batteries, 2020.
[8] Y. Wu et al., “Ion-Sieving Carbon Nanoshells for Deeply Rechargeable Zn-Based Aqueous Batteries,” Advanced Energy Materials, vol. 8, no. 36, 2018.
[9] Y. Zhang, J. D. Howe, S. Ben-Yoseph, Y. Wu, and N. Liu, “Unveiling the Origin of Alloy-Seeded and Nondendritic Growth of Zn for Rechargeable Aqueous Zn Batteries,” ACS Energy Letters, vol. 6, no. 2, 2021.
[10] S. H. Park et al., “High areal capacity battery electrodes enabled by segregated nanotube networks,” Nature Energy, vol. 4, no. 7, 2019.
[11] K. Okuyama and W. W. Lenggoro, “Preparation of nanoparticles via spray route,” Chemical Engineering Science, vol. 58, no. 3-6, pp. 537-547, February 2003.
[12] R. Mueller, L. Madler, and S. E. Pratsinis, “Nanoparticle synthesis at high production rates by flame spray pyrolysis,” Chemical Engineering Science, vol. 58, no. 10, pp. 1969-1976 May 2003.
[13] S. C. Tsai, Y. L. Song, C. S. Tsai, C. C. Yang, W. Y. Chiu, and H. M. Lin, “Ultrasonic spray pyrolysis for nanoparticles synthesis,” Journal of Materials Science, vol. 39, no. 11, 2004.
[14] Y. J. Hong, M. Y. Son, and Y. C. Kang, “One-pot facile synthesis of double-shelled SnO2 yolk-shell-structured powders by continuous process as anode materials for li-ion batteries,” Advanced Materials, vol. 25, no. 16, 2013.
[15] A. Stunda-Zujeva, Z. Irbe, and L. Berzina-Cimdina, “Controlling the morphology of ceramic and composite powders obtained via spray drying—A review,” Ceramics International, vol. 43, no. 15, pp. 11543-11551, October 2017.
[16] R. Balgis, T. Ogi, A. F. Arif, G. M. Anilkumar, T. Mori, and K. Okuyama, “Morphology control of hierarchical porous carbon particles from phenolic resin and polystyrene latex template via aerosol process,” Carbon, vol. 84, no. 1, pp. 281-289, April 2015.
[17] J. Zhou, H. Zhao, J. Wang, W. Qiao, D. Long, and L. Ling, “Scalable preparation of hollow polymer and carbon microspheres by spray drying and their application in low-density syntactic foam,” Materials Chemistry and Physics, vol. 181, pp. 150-158, September 2016.
[18] M. Li et al., “Facile spray-drying/pyrolysis synthesis of core-shell structure graphite/silicon porous carbon composite as a superior anode for Li-ion batteries,” Journal of Power Sources, vol. 248, pp. 721-728, February 2014.
[19] Y. J. Hong and Y. C. Kang, “One-pot synthesis of core-shell-structured tin oxide-carbon composite powders by spray pyrolysis for use as anode materials in Li ion batteries,” Carbon, vol. 88, pp. 262-269, July 2015.
[20] B. Zou, Y. Wang, and S. Zhou, “Spray drying-assisted synthesis of LifePO4/C composite microspheres with high performance for lithium-ion batteries,” Materials Letters, vol. 92, pp. 300-303, February 2013.
[21] T. H. Wu, Y. Zhang, Z. D. Althouse, and N. Liu, Nanoscale design of zinc anodes for high-energy aqueous rechargeable batteries, June 2019.
[22] T. F. Fuller and J. N. Harb, Electrochemical engineering/Thomas F. Fuller, (Georgia Institute of Technology, US), John N. Harb, (Brigham Young University, US), 1. 2018, vol. 1.
[23] John Denker, Standard Reduction Potentials, 2007.
[24] Y. Yan et al., “A Lasagna-Inspired Nanoscale ZnO Anode Design for High-Energy Rechargeable Aqueous Batteries,” ACS Applied Energy Materials, vol. 1, no. 11, 2018.
[25] Y. Zhang et al., “Sealing ZnO nanorods for deeply rechargeable high-energy aqueous battery anodes,” Nano Energy, vol. 53, pp. 666-674, November 2018.
[26] Y. Zhang et al., “Deeply Rechargeable and Hydrogen-Evolution-Suppressing Zinc Anode in Alkaline Aqueous Electrolyte,” Nano Letters, vol. 20, no. 6, 2020.
[27] L. Yuan, J. Xu, Z. Yang, Q. Su, and J. Li, “Zinc oxide anode modified with zeolite imidazole structure achieve stable circulation for zinc-nickel secondary battery,” Journal of Power Sources, vol. 517, p. 230 696, January 2022.
[28] J. F. Parker, I. R. Pala, C. N. Chervin, J. W. Long, and D. R. Rolison, “Minimizing Shape Change at Zn Sponge Anodes in Rechargeable Ni—Zn Cells: Impact of Electrolyte Formulation,” Journal of The Electrochemical Society, vol. 163, no. 3, 2016.
[29] T. C. Adler, F. R. McLarnon, and E. J. Cairns, “Low-Zinc-Solubility Electrolytes for Use in Zinc/Nickel Oxide Cells,” Journal of The Electrochemical Society, vol. 140, no. 2, 1993.
[30] J. F. Parker et al., “Rechargeable nickel-3D zinc batteries: An energy-dense, safer alternative to lithium-ion,” Science, vol. 356, no. 6336, 2017.
[31] M. Eisenberg, ALKALINE GALVANIC CELLS, June 1993.
[32] A. P. Pavlov, L. K. Grigorieva, S. P. Chizhik, and V. K. Stankov, “Nickel-zinc batteries with long cycle life,” Journal of Power Sources, vol. 62, no. 1, pp. 113-116, September 1996.
[33] J. McBreen, “Nickel/zinc batteries,” Journal of Power Sources, vol. 51, no. 1-2, pp. 37-44, August 1994.
[34] G. Bronoel, A. Millot, and N. Tassin, “Development of NiZn cells,” Journal of Power Sources, vol. 34, no. 3, pp. 243-255, April 1991.
[35] S. Xiong, Y. Wang, J. Yu, L. Chen, J. Zhu, and Z. Hu, “Polydopamine particles for next-generation multifunctional biocomposites,” Journal of Materials Chemistry A, vol. 2, no. 20, 2014.
[36] G. Trovati, E. A. Sanches, S. C. Neto, Y. P. Mascarenhas, and G. 0. Chierice, “Characterization of polyurethane resins by FTIR, TGA, and XRD,” Journal of Applied Polymer Science, vol. 115, no. 1, 2010.
[37] J. Song, K. Xu, N. Liu, D. Reed, and X. Li, “Crossroads in the renaissance of rechargeable aqueous zinc batteries,” Materials Today, vol. 45, pp. 191-212, May 2021.
[38] W. Sun et al., “A rechargeable zinc-air battery based on zinc peroxide chemistry,” Science, vol. 371, no. 6524, 2021.
[39] S. Lin, L. Dong, J. Zhang, and H. Lu, “Room-Temperature Intercalation and 1000-Fold Chemical Expansion for Scalable Preparation of High-Quality Graphene,” Chemistry of Materials, vol. 28, no. 7, 2016.
[40] MESH AND MICRON SIZES, November 2021.
[41] J. Mittal, H. Konno, and M. Inagaki, “Synthesis of graphite intercalation compounds with CrVI compounds using Cr03 and HCl at room temperature,” Synthetic Metals, vol. 96, no. 2, pp. 103-108, July 1998.
[42] J. Zheng et al., “Reversible epitaxial electrodeposition of metals in battery anodes,” Science, pp. 645-648, November 2019.
[43] S. Jin et al., “Stabilizing Zinc Electrodeposition in a Battery Anode by Controlling Crystal Growth,” Small, vol. 17, no. 33, 2021.
[44] J. Zheng et al., “Regulating electrodeposition morphology in high-capacity aluminium and zinc battery anodes using interfacial metal-substrate bonding,” Nature Energy, vol. 6, no. 4, 2021.
[45] M. Cui et al., “Quasi-Isolated Au Particles as Heterogeneous Seeds to Guide Uniform Zn Deposition for Aqueous Zinc-Ion Batteries,” ACS Applied Energy Materials, vol. 2, no. 9, 2019.
[46] H. Liu, Y. Zhang, C. Wang, J. N. Glazer, Z. Shan, and N. Liu, “Understanding and Controlling the Nucleation and Growth of Zn Electrodeposits for Aqueous Zinc-Ion Batteries,” ACS Applied Materials and Interfaces, vol. 13, no. 28, 2021.
[47] W. Sun et al., “Zn/MnO2 Battery Chemistry with H+ and Zn2+ Co-insertion,” Journal of the American Chemical Society, vol. 139, no. 29, 2017.
[48] B. Tang, L. Shan, S. Liang, and J. Zhou, Issues and opportunities facing aqueous zinc-ion batteries, 2019.

1. A method of forming a plurality of core/shell nanoparticles comprising:
spray coating a plurality of ZnO particles with a carbon precursor to form a plurality of clusters having a ZnO-based core and a carbon-containing shell.

2. The method of claim 1, wherein the carbon precursor is an organic material.

3. The method of claim 1, wherein the carbon precursor is a polymeric resin.

4. The method of claim 1, wherein the plurality of clusters having a ZnO-based core and a carbon-based shell are heated to carbonize the carbon-containing shell to form a carbon-based ion-sieving shell.

5. The method of claim 4, wherein the carbon-based ion-sieving shell is microporous.

6. The method of claim 4, wherein the carbon precursor is a slurry comprising an organic material, water, and zinc oxide.

7. The method of claim 2, wherein the organic material comprises resol, resorcinol-formaldehyde, citric acid, polyurethane, sucrose, polyvinyl propylene, polyvinylalcohol, or any combination thereof.

8. The method of claim 6, wherein a mass ratio of zinc oxide and the organic material is from about 3:1 to 1:2.

9. The method of claim 4, wherein the heating is at a temperature of about 500° C. to about 1,000° C.

10. The method of claim 4, wherein the heating is an inert atmosphere.

11. The method of claim 4, wherein the plurality of clusters having the ZnO-based core and the carbon-based ion-sieving shell have a substantially spherical shape.

12. The method of claim 1, wherein ZnO-based core comprises from about 1,000 to about 10,000 ZnO nanoparticles.

13. The method of claim 4, wherein the carbon-based ion-sieving shell is permeable for OH⁻.

14. The method of claim 4, wherein the carbon-based ion-sieving shell is impermeable for Zn⁺².

15. The method of claim 4, wherein the plurality of core/shell nanoparticles behave as an anode material.

16. An electrochemical cell comprising:
an anode electrode comprising a plurality of core/shell nanoparticles of claim 4 and
an aqueous electrolyte.

17. The electrochemical cell of claim 16, wherein the aqueous electrolyte comprises one or more zinc salts.

18. The electrochemical cell of claim 17, wherein the one or more zinc salts comprises zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof.

19. The electrochemical cell of claim 16, wherein the aqueous electrolyte has a pH from greater than about 7 to about 15.

20. The electrochemical cell of claim 16, wherein the electrochemical cell is a rechargeable battery.

21-30. (canceled)
